(19) United States
(12) Patent Application Publication
(10) Pub. No.: US 2010/0098907 A1
(43) Pub. Date: Apr. 22, 2010

(54) MOLDING COMPOUND FOR MATT MOLDED POLYACRYLATE BODIES

(75) Inventors: Klaus Schultes, Darmstadt (DE); Ursula Golchert, Dieburg (DE); Stefan Nau, Buettelborn (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Evonik Roehm GmbH, Darmstadt (DE)

(21) Appl. No.: 12/521,004

(22) PCT Filed: Oct. 30, 2007
(86) PCT No.: PCT/EP2007/061647

§ 371 Date: Jun. 24, 2009

(30) Foreign Application Priority Data
Jan. 30, 2007 (DE) 10 2007 005 432.9

(51) Int. Cl. B32B 3/00; C04B 35/00; B29C 45/00

(52) U.S. Cl. 428/141; 501/1; 501/153; 264/328.1

(57) ABSTRACT

Moulding composition, comprising, based in each case on the total weight of the moulding composition,
A) from 49.5% by weight to 99.5% by weight of a polymer matrix which is composed of a (meth)acrylate (co)polymer or of a mixture composed of (meth)acrylate (co)polymer,
B) from 0.5% by weight to 15.0% by weight of ceramic beads,
   where the melt volume index MVR, measured to ISO 1133 for 230° C. and 3.8 kg, of the moulding composition is from 0.1 cm³/10 min to 5.0 cm³/10 min.

The moulding composition can be used for production of mouldings with a velvet-matt and preferably rough surface. These mouldings are particularly suitable as parts of household devices, of communications devices, of hobby equipment or of sports equipment, or as bodywork parts or parts of bodywork parts in automobile construction, shipbuilding or aircraft construction, or as parts for illuminants, signs or symbols, retail outlets or cosmetics counters, containers, household-decoration items or office-decoration items, furniture applications, shower doors and office doors, or else as parts in the construction industry, as walls, as window frames, bench seats, lamp covers, diffuser sheets, or for automobile glazing.

The invention relates to a moulding composition for matt mouldings, and also to the corresponding mouldings and their use.

### PRIOR ART

Moulding compositions based on polymethyl methacrylate (PMMA) are used for a very wide variety of applications. To this end, the compositions are usually injection-moulded or extruded to give mouldings. These mouldings feature the properties typical of PMMA, e.g. high scratch resistance, weathering resistance, heat resistance, and excellent mechanical properties, such as modulus of elasticity, and good stress-cracking resistance.

Extruded or co-extruded PMMA mouldings are very versatile: by way of example, extruded or co-extruded sheets are used not only for exteriors, in particular for automobile add-on parts, construction components, sports-equipment surfaces and lamp covers, but also in interiors, in particular in the furniture industry, and for lamp covers and interior fitting-out of automobiles.

These applications do not only require extruded or coextruded PMMA mouldings with a transparent, smooth surface but also often require matt, and preferably rough, surfaces, because these have more attractive feel and because of the optical effect. This type of surface is mostly achieved by using moulding compositions into which organic or inorganic particles have been incorporated.

However, when organic matting agents are used, the resulting modified moulding compositions do not exhibit good mechanical properties, and in particular do not exhibit satisfactory abrasion resistance. It is also often necessary to use large amounts of light stabilizers in order to achieve good weathering resistance of the corresponding mouldings.

A disadvantage in the processing of the inorganic matting agents commonly used, e.g. talc, is complicated incorporation into the PMMA moulding composition. By way of example, very high shear energies have to be used during compounding, in order to incorporate the inorganic matting agent uniformly into the moulding composition. If homogeneous distribution of the scattering agent in the moulding composition has not been ensured, this is discernible at the surface of the resultant extruded or co-extruded PMMA mouldings (defects or irregularities, e.g. pimples). The other properties of the material of such mouldings are also unsatisfactory.

WO 02/068519 describes a solid surface material composed of a matrix, e.g. of PMMA, and of ceramic beads dispersed therein, for example W-410 Zeeospheres®. The ceramic beads have a functional coating which reacts with the resin of the matrix and covalently bonds the beads to the matrix. The surface material of WO 02/068519 features high flame resistance.

WO 03/054099 relates to an adhesive strip whose uppermost layer encompasses a transparent resin and a matting agent, e.g. ceramic beads.

WO 97/21536 discloses an extrusion process which can be used to introduce matting agents, e.g. ceramic beads, into a thermoplastic polymer.

U.S. Pat. No. 5,787,655 describes an anti-slip film composed of a thermoplastic polymer, into which inorganic beads, e.g. ceramic beads, have been incorporated.

U.S. Pat. No. 5,562,981 relates to the structure of a lorry trailer. The side walls of the trailer encompass fibre-reinforced plastics into which ceramic beads were mixed for additional reinforcement of the walls.

WO 2005/105377 discloses a composition composed of a thermoplastic whose processing temperature is at least 280° C., of super-abrasive particles and of a filler, e.g. ceramic beads. The composition is used for production of abrasive articles.

### OBJECTS AND ACHIEVEMENT OF OBJECTS

It was then an object of the present invention to find a moulding composition which can be used for production of mouldings with a fine-matt surface. This moulding composition should be preparable and processable in the simplest possible manner, in particular with relatively low energy cost. The articles that can be produced from the moulding composition should moreover have the best possible optical and mechanical properties, the best possible long-term stability and weathering resistance, and also a velvet-matt surface which has the least possible gloss and the greatest possible homogeneity. The articles that can be produced from the moulding composition should also, if possible, have a rough surface.

A moulding composition with all of the features of the present claim 1 achieves these objects, and also achieves further objects which are a necessary consequence of the above discussion or result directly therefrom. The subclaims dependent on the said claim describe particularly advantageous embodiments of the moulding composition, and the further claims relate to particularly advantageous applications of the compositions.

Provision of a composition which comprises, based in each case on the total weight of the composition,
A) from 49.5% by weight to 99.5% by weight of a polymer matrix which is composed of a (meth)acrylate (co)polymer or of a mixture composed of (meth)acrylate (co)polymer,
B) from 0.5% by weight to 15.0% by weight of ceramic beads,
   where the melt volume index MVR, measured to ISO 1133 for 230° C. and 3.8 kg, of the moulding composition is from 0.1 cm³/10 min to 5.0 cm³/10 min, provides a method not readily foreseeable for access to a moulding composition which has excellent suitability for production of mouldings with a fine-matt surface. The moulding composition here is processable and preparable in a comparatively simple manner, in particular with relatively low energy cost, and also permits realization of demanding component geometries.

At the same time, the articles that can be produced from the moulding composition feature a combination of advantageous properties, composed of:
They have very good optical properties, in particular a comparatively homogeneous velvet-matt surface with very low gloss. This effect was further reinforced via an attractive surface roughness of the mouldings.
They exhibit excellent mechanical properties, in particular very good abrasion resistance, impact resistance and notched impact resistance, high modulus of elasticity and high tensile strength, high scratch hardness and high Vicat softening point, and also low coefficient of thermal expansion.
The long-term stability and weathering resistance of the mouldings is likewise excellent.

### BRIEF DESCRIPTION OF THE INVENTION

### Polymer Matrix A)

Polymer matrix A) is composed of a (meth)acrylate (co)polymer or of a mixture of (meth)acrylate (co)polymers.

### (Meth) Acrylate (Co) Polymers

For the purposes of one first particularly preferred embodiment of the present invention, the (meth)acrylate (co)polymer of the matrix encompasses a homopolymer or copolymer composed of at least 80.0% by weight of methyl methacrylate and, if appropriate, up to 20.0% by weight of further monomers copolymerizable with methyl methacrylate. The (meth)acrylate (co)polymer is advantageously composed of from 80.0% by weight to 100.0% by weight, preferably from 90.0% by weight to 99.5% by weight, of methyl methacrylate units polymerized by a free-radical route and, if appropriate, from 0.0% by weight to 20.0% by weight, preferably from 0.5% by weight to 10% by weight, of further comonomers capable of free-radical polymerization, e.g. C1-C4-alkyl (meth)acrylates, in particular methyl acrylate, ethyl acrylate or butyl acrylate. The average molar mass M_{w} of the matrix is preferably in the range from 90 000 g/mol to 200 000 g/mol, in particular from 95 000 g/mol to 180 000 g/mol.

The polymer matrix is preferably composed of a (meth)acrylate (co)polymer composed of from 96.0% by weight to 100.0% by weight, preferably from 97.0% by weight to 100.0% by weight, particularly preferably from 98.0% by weight to 100.0% by weight, of methyl methacrylate and from 0.0% by weight to 4.0% by weight, preferably from 0.0% by weight to 3.0% by weight, in particular from 0.0% by weight to 2.0% by weight, of methyl acrylate, ethyl acrylate and/or butyl acrylate.

The solution viscosity of the (meth)acrylate (co)polymers in chloroform at 25° C. (ISO 1628—Part 6) is preferably from 45.0 ml/g to 80.0 ml/g, with preference from 50.0 ml/g to 75.0 ml/g. This can correspond to a molar mass M_{w} (weight-average) in the range from 80 000 to 200 000 (g/mol), preferably from 100 000 to 170 000. The molar mass M_{w} can by way of example be determined by gel permeation chromatography or by a scattered-light method (see, for example, H. F. Mark et al., Encyclopedia of Polymer Science and Engineering, 2^{nd} Edition, Vol. 10, pages 1 et seq., J. Wiley, 1989).

The Vicat softening point VSP (ISO 306-B50) is preferably at least 100° C., particularly preferably at least 104° C., still more preferably from 104° C. to 114° C. and in particular from 105° C. to 110° C.

The melt volume index MVR (ISO 1133, 230° C./3.8 kg) of the polymer is advantageously in the range from 0.5 cm³/10 min to 5.0 cm³/10 min, particularly preferably in the range from 1.0 cm³/10 min to 2.9 cm³/10 min.

### (Meth)Acrylate (Co)Polymers Containing Maleic Anhydride

For the purposes of a second particularly preferred embodiment of the present invention, the (meth)acrylate (co)polymer of the matrix encompasses a copolymer composed of methyl methacrylate, styrene and maleic anhydride.

Solution viscosity in chloroform at 25° C. (ISO 1628-Part 6) is preferably greater than or equal to 65 ml/g, with preference from 68 ml/g to 75 ml/g. This can correspond to a molar mass M_{w} (weight-average) of 130 000 g/mol (M_{w} being determined by means of gel permeation chromatography with reference to a polymethyl methacrylate calibration standard). The molar mass M_{w} can by way of example be determined by gel permeation chromatography or by a scattered-light method (see, for example, H. F. Mark et al., Encyclopedia of Polymer Science and Engineering, 2^{nd} Edition, Vol. 10, pages 1 et seq., J. Wiley, 1989).

The Vicat softening point VSP (ISO 306-B50) is advantageously at least 112° C., particularly preferably from 114° C. to 124° C., in particular from 118° C. to 122° C.

The melt volume index MVR (ISO 1133, 230° C./3.8 kg) of the polymer is advantageously in the range from 0.5 cm³/10 min to 5.0 cm³/10 min, particularly preferably in the range from 1.0 cm³/10 min to 2.9 cm³/10 min.

Particularly suitable quantitative proportions are: from 50% by weight to 90% by weight, preferably from 70% by weight to 80% by weight, of methyl methacrylate, from 10% by weight to 20% by weight, preferably from 12% by weight to 18% by weight, of styrene, and from 5% by weight to 15% by weight, preferably from 8% by weight to 12% by weight, of maleic anhydride.

The use of polymer mixtures has moreover also proved very particularly successful. These preferably encompass
d) at least one low-molecular-weight (meth)acrylate (co)polymer, characterized via a solution viscosity in chloroform at 25° C. (ISO 1628—Part 6) smaller than or equal to 55 ml/g, preferably smaller than or equal to 50 ml/g, in particular from 45 ml/g to 55 ml/g (where this can correspond to a molar mass M_{w} (weight-average) of 95 000 g/mol (M_{w} being determined by means of gel permeation chromatography with reference to a polymethyl methacrylate calibration standard)),
   in a mixture with
e) a relatively high-molecular-weight (meth)acrylate (co)polymer, characterized via a solution viscosity in chloroform at 25° C. (ISO 1628—Part 6) greater than or equal to 65 ml/g, preferably from 68 ml/g to 75 ml/g and/or
f) a further (meth)acrylate (co)polymer differing from d) and characterized via a solution viscosity in chloroform at 25° C. (ISO 1628—Part 6) of from 50 ml/g to 55 ml/g, preferably from 52 ml/g to 54 ml/g (and this can correspond to a molar mass M_{w} (weight-average) in the range from 80 000 to 200 000 (g/mol), preferably from 100 000 to 150 000),
   where each of components d), e), and/or f) individually can be an individual polymer or else a mixture of polymers, and
   the total of d), e) and/or f) is preferably 100.0% by weight and
   where the polymer mixture of d), e) and/or f) can also comprise conventional additives, auxiliaries and/or fillers.

The following proportions are particularly preferred: Component d): preferably from 25.0% by weight to 75.0% by weight, with preference from 40.0% by weight to 60.0% by weight, in particular from 45% by weight to 55.0% by weight.

Component d) and/or f): from 10.0% by weight to 50.0% by weight, preferably from 12.0% by weight to 40.0% by weight.

Each of components d) and e) advantageously a copolymer composed of methyl methacrylate, styrene and maleic anhydride.

Particularly suitable quantitative proportions are: from 50% by weight to 90% by weight, preferably from 70% by weight to 80% by weight, of methyl methacrylate, from 10% by weight to 20% by weight, preferably from 12% by weight to 18% by weight, of styrene and from 5% by weight to 15% by weight, preferably from 8% by weight to 12% by weight, of maleic anhydride.

Component f) is preferably a homopolymer or copolymer composed of at least 80% by weight of methyl methacrylate and, if appropriate, up to 20% by weight of further monomers copolymerizable with methyl methacrylate.

Component f) is advantageously composed of from 80.0% by weight to 100.0% by weight, preferably from 90.0% by weight to 99.5% by weight, of methyl methacrylate units polymerized by a free-radical route and, if appropriate, from 0.0% by weight to 20.0% by weight, preferably from 0.5% by weight to 10% by weight, of further comonomers capable of free-radical polymerization, e.g. C1-C4-alkyl (meth)acrylates, in particular methyl acrylate, ethyl acrylate or butyl acrylate. The average molar mass M_{w} of the matrix is preferably in the range from 90 000 g/mol to 200 000 g/mol, in particular from 100 000 g/mol to 150 000 g/mol.

Component f) is preferably a copolymer composed of from 95.0% by weight to 99.5% by weight of methyl methacrylate and from 0.5% by weight to 5.0% by weight, preferably from 1.0% by weight to 4.0% by weight, of methyl acrylate.

The Vicat softening point VSP (ISO 306-B50) of component f) is preferably at least 107° C., particularly preferably from 108° C. to 114° C. The melt volume index MVR (ISO 1133, 230° C./3.8 kg) is preferably greater than or equal to 2.5 cm³/10 min.

The abovementioned copolymers can be obtained in a manner known per se via free-radical polymerization. EP A 264 590 describes by way of example a process for preparation of a moulding composition composed of a monomer mixture composed of methyl methacrylate, vinylaromatic compound, maleic anhydride, and also, if appropriate, a lower alkyl acrylate, by carrying out the polymerization to a conversion of 50% in the presence or absence of a non-polymerizable organic solvent and, starting at a conversion of at least 50%, continuing the polymerization in the temperature range from 75° C. to 150° C. in the presence of an organic solvent to a conversion of at least 80%, and then evaporating the volatile low-molecular-weight constituents.

JP-A 60-147 417 describes a process for preparation of a highly heat-resistant polymethacrylate moulding composition in which a monomer mixture composed of methyl methacrylate and of maleic anhydride, and of at least one vinylaromatic compound is fed to a polymerization reactor suitable for solution polymerization or bulk polymerization at a temperature of from 100 to 180° C. and is polymerized. DE-A 44 40 219 describes a further preparation process.

Component A) can, for example, be prepared by taking a monomer mixture composed of 3000 g of methyl methacrylate, 600 g of styrene and 400 g of maleic anhydride and admixing 1.68 g of dilauroyl peroxide and 0.4 g of tert-butyl perisononanoate as polymerization initiator, 6.7 g of 2-mercaptoethanol as molecular-weight regulator, and also 4 g of 2-(2-hydroxy-5-methylphenyl)benzotriazole as UV absorber and 4 g of palmitic acid as mould-release agent.

The resultant mixture is charged to a polymerization cell and devolatilized for 10 minutes. The mixture is then polymerized in a water bath for 6 hours at 60° C. and for 25 hours at 50° C. water-bath temperature. After about 25 hours, the polymerization mixture reaches 144° C., its maximum temperature. After removal from the polymerization cell, the polymer is further heat-conditioned in an oven under air at 120° C. for 12 hours.

The resultant copolymer is clear, with yellowness index to DIN 6167) (D65/10° of 1.4 on a pressed sheet of thickness 8 mm and with TD65 light transmittance of 90.9% to DIN 5033/5036. The Vicat softening point VSP of the copolymer to ISO 306-B50 is 121° C., and the reduced viscosity nsp/c is 65 ml/g, corresponding to an average molecular weight M_{w} of about 130 000 daltons (based on a polymethyl methacrylate standard).

Component d) can, for example, be prepared by taking a monomer mixture composed of, for example, 6355 g of methyl methacrylate, 1271 g of styrene and 847 g of maleic anhydride, and admixing 1.9 g of tert-butyl perneodecanoate and 0.85 g of tert-butyl 3,5,5-tri-methylperoxyhexanoate as polymerization initiator, and 19.6 g of 2-mercaptoethanol as molecular-weight regulator, and also 4.3 g of palmitic acid. The resultant mixture can be charged to a polymerization cell and, for example, devolatilized for 10 minutes. It can then be polymerized in a water bath, for example for 6 hours at 60° C., and then for 30 hours at 55° C. water-bath temperature. After about 30 hours, the polymerization mixture reaches 126° C., which is its maximum temperature. After removal of the polymerization cell from the water bath, the polymer is, as for component a), in the polymerization cell, further heat-conditioned for about 7 hours, for example at 117° C., in an oven under air.

### Matting Agent B): Ceramic Beads

The inventive moulding composition further comprises from 0.5% by weight to 15.0% by weight of ceramic beads. Ceramics are articles substantially composed of inorganic, fine-grain raw materials and moulded at room temperature with addition of water and then dried, and then sintered in a subsequent firing process at above 900° C. to give hard, durable articles. The term also includes materials based on metal oxides. The group of ceramics that can be used according to the invention also includes fibre-reinforced ceramic materials, e.g. silicon carbide ceramics which can, for example, be produced from silicon-containing organic polymers (polycarbosilanes) as starting material.

The ceramic beads advantageously have no covalent bonding to the polymer matrix and can in principle be separated from the polymer matrix via physical separation methods, e.g. extraction processes using suitable solvents, e.g. tetrahydrofuran (THF).

The ceramic beads moreover preferably have a spherical shape, but it is naturally possible that slight deviations from the perfect spherical shape occur.

The diameter of the ceramic beads is advantageously in the range from 1 to 200 μm. The median diameter (median value D₅₀) of the ceramic beads is preferably in the range from 1.0 μm to 15.0 μm. The D95 value is preferably smaller than or equal to 35 μm, particularly preferably smaller than or equal to 13 μm. The maximum diameter of the beads is preferably smaller than or equal to 40 μm, particularly preferably smaller than or equal to 13 μm. The particle size of the beads is preferably determined via sieve analysis.

The density of the ceramic beads is advantageously in the range from 2.1 g/cm³ to 2.5 g/cm³.

The specific constitution of the ceramic beads is of relatively little importance for the present invention. Preferred beads comprise, based in each case on their total weight,
from 55.0% by weight to 62.0% by weight of SiO₂,
particularly preferably non-crystalline SiO₂,
from 21.0% by weight to 35.0% by weight of Al₂O₃,
up to 7.0% by weight of Fe₂O₃,
up to 11.0% by weight of Na₂O and
up to 6.0% by weight of K₂O.

The surface area of the ceramic beads, measured by the BET nitrogen-adsorption method, is preferably in the range from 0.8 m²/g to 2.5 m²/g.

It has moreover proved particularly successful for the purposes of the present invention to use ceramic beads which are internally hollow. The compressed strength of the ceramic beads here is preferably such that more than 90% of the beads are not damaged when a pressure of 410 MPa is applied.

For the purposes of the present invention, very particularly suitable ceramic beads are, inter alia, Zeeospheres® from 3M Deutschland GmbH, in particular the grades W-210, W-410, G-200 and G-400.

### Impact Modifier C)

The inventive moulding composition preferably comprises an impact modifier, particularly preferably an impact modifier based on crosslinked poly(meth)acrylates. The impact modifier here preferably has no covalent bonding to the polymer matrix A). Component C) preferably has a two- or three-shell structure.

Particularly preferred impact modifiers are polymer particles which have a two-layer, particularly preferably a three-layer, core-shell structure and which can be obtained via emulsion polymerization (see, for example, EP-A 0 113 924, EP-A 0 522 351, EP-A 0465 049 and EP-A 0 683 028). Typical particle sizes of these emulsion polymers are in the range from 100 nm to 500 nm, preferably from 200 nm to 450 nm.

A three-layer or three-phase structure with a core and two shells can in particular take the following form. An innermost (hard) shell can, for example, be composed in essence of methyl methacrylate, of small proportions of comonomers, e.g. ethyl acrylate, and of a proportion of crosslinking agent, e.g. allyl methacrylate. The middle (soft) shell can, for example, be composed of butyl acrylate and, if appropriate, styrene, and also of a proportion of crosslinking agent, e.g. allyl methacrylate, while the outermost (hard) shell mostly in essence corresponds to the matrix polymer, the result being compatibility and good coupling to the matrix. The proportion of polybutyl acrylate in the impact modifier is decisive for impact resistance and is preferably in the range from 20.0% by weight to 40.0% by weight, particularly preferably in the range from 25.0% by weight to 40.0% by weight.

Other impact-modified polymethacrylate moulding compositions particularly suitable for the purposes of the present invention are described by way of example in EP-A 0 113 924, EP-A 0 522 351, EP-A 0 465 049, EP-A 0 638 028 and U.S. Pat. No. 3,793,402. An example of a very particularly suitable commercially available product is METABLEN® IR 441 from Mitsubishi Rayon.

The moulding composition advantageously comprises from 5.0% by weight to 50.0% by weight, preferably from 10.0% by weight to 20.0% by weight, particularly preferably from 10.0% by weight to 15.0% by weight, of an impact modifier which is an elastomer phase composed of crosslinked polymer particles. The impact modifier is obtained in a manner known per se via bead polymerization or via emulsion polymerization.

For the purposes of another particularly preferred embodiment of the present invention, the impact modifier is crosslinked particles which are obtainable by means of bead polymerization and which have an average particle size in the range from 50 μm to 500 μm, preferably from 80 μm to 120 μm. These are generally composed of at least 40.0% by weight, preferably from 50.0% by weight to 70.0% by weight, of methyl methacrylate, from 20.0% by weight to 40.0% by weight, preferably from 25.0% by weight to 35.0% by weight, of butyl acrylate, and also from 0.1% by weight to 2.0% by weight, preferably from 0.5% by weight to 1.0% by weight, of a crosslinking monomer, e.g. a polyfunctional (meth)acrylate, such as allyl methacrylate, and, if appropriate, further monomers, e.g. from 0.0% by weight to 10.0% by weight, preferably from 0.5% by weight to 8.0% by weight, of C₁-C₄-alkyl (meth)acrylates, such as ethyl acrylate or butyl acrylate, or preferably methyl acrylate, or other monomers polymerizable by a vinylic route, e.g. styrene.

Conventional Additives, Auxiliaries and/or Fillers

The inventive moulding composition can also comprise conventional additives, auxiliaries and/or fillers, e.g. heat stabilizers, UV stabilizers, UV absorbers, antioxidants, and in particular soluble or insoluble dyes and, respectively, other colorants.

### UV Stabilizers and Free-Radical Scavengers

Examples of optionally present UV stabilizers are derivatives of benzophenone, its substituents such as hydroxy and/or alkoxy groups, being mostly in 2- and/or 4-position. Among these are 2-hydroxy-4-n-octoxybenzo-phenone, 2,4-dihydroxybenzophenone, 2,2′-dihydroxy-4-methoxybenzophenone, 2,2′,4,4′-tetrahydroxybenzo-phenone, 2,2′-dihydroxy-4,4′-dimethoxybenzophenone, 2-hydroxy-4-methoxybenzophenone. Substituted benzotria-zoles are moreover very suitable as UV stabilizer additive, and among these are especially 2-(2-hydroxy-5-methylphenyl)benzotriazole, 2-[2-hydroxy-3,5-di-(alpha, alpha-dimethylbenzyl)phenyl]benzotriazole, 2-(2-hydroxy-3,5-di-tert-butylphenyl)benzotriazole, 2-(2-hydroxy-3,5-butyl-5-methylphenyl)-5-chlorobenzo-triazole, 2-(2-hydroxy-3,5-di-tert-butylphenyl)-5-chlorobenzotriazole, 2-(2-hydroxy-3,5-di-tert-amyl-phenyl)benzotriazole, 2-(2-hydroxy-5-tert-butylphenyl)-benzotriazole, 2-(2-hydroxy-3-sec-butyl-5-tert-butyl-phenyl)benzotriazole and 2-(2-hydroxy-5-tert-octyl-phenyl)benzotriazole.

Other UV stabilizers that can be used are ethyl 2-cyano-3,3-diphenylacrylate, 2-ethoxy-2′-ethyl-oxanilide, 2-ethoxy-5-tert-butyl-2′-ethyloxanilide and substituted phenyl benzoates.

The UV stabilizers can be present in the form of low-molecular-weight compounds, as given above, in the polymethacrylate compositions to be stabilized. However, it is also possible that UV-absorbent groups have covalent bonding within the matrix polymer molecules after copolymerization with polymerizable UV-absorption compounds, e.g. acrylic, methacrylic or allyl derivatives of benzophenone derivatives or of benzotriazole derivatives.

The proportion of UV stabilizers, and this can also be mixtures of chemically different UV stabilizers, is generally from 0.01% by weight to 1.0% by weight, especially from 0.01% by weight to 0.5% by weight, in particular from 0.02% by weight to 0.2% by weight, based on the entirety of all of the constituents of the inventive polymethacrylate resin.

An example that may be mentioned here as free-radical scavengers/UV stabilizers is sterically hindered amines, known as HALS (Hindered Amine Light Stabilizer). They can be used for inhibiting ageing processes in coatings and plastics, especially in polyolefin plastics (Kunststoffe, 74 (1984) 10, pp. 620 to 623; Farbe+Lack, Volume 96, 9/1990, pp. 689 to 693). The tetramethylpiperidine group present in the HALS compounds is responsible for their stabilizing action. This class of compounds can have no substitution on the piperidine nitrogen or else have substitution thereon by alkyl or acyl groups. The sterically hindered amines do not absorb in the UV region. They scavenge free radicals formed, the function of which the UV absorbers are in turn not capable.

Examples of HALS compounds having stabilizing action, which can also be used in the form of mixtures, are: bis(2,2,6,6-tetramethyl-4-piperidyl) sebacate, 8-acetyl-3-dodecyl-7,7,9,9-tetramethyl-1,3,8-triaza-spiro(4,5)decane-2,5-dione, bis(2,2,6,6-tetramethyl-4-piperidyl) succinate, poly(N-(β-hydroxyethyl-2,2,6,6-tetramethyl-4-hydroxypiperidine succinate) or bis(N-methyl-2,2,6,6-tetramethyl-4-piperidyl) sebacate.

The amounts used of the free-radical scavengers/UV stabilizers in the inventive moulding compositions are from 0.01% by weight to 1.5% by weight, especially from 0.02% by weight to 1.0% by weight, in particular from 0.02% by weight to 0.5% by weight, based on the entirety of all of the constituents.

### Lubricants or Mould-Release Agents

Lubricants or mould-release agents are particularly important for the injection-moulding process, and can reduce or entirely prevent any possible adhesion of the moulding composition to the injection mould.

Auxiliaries that can accordingly be present comprise lubricants, e.g. selected from the group of the saturated fatty acids having fewer than 20, preferably from 16 to 18, carbon atoms, or from that of the saturated fatty alcohols having fewer than 20, preferably from 16 to 18, carbon atoms. Small quantitative proportions are preferably present: at most 0.25% by weight, e.g. from 0.05% by weight to 0.2% by weight, based on the moulding composition.

Examples of suitable materials are stearic acid, palmitic acid, and technical mixtures composed of stearic and palmitic acid. Other examples of suitable materials are n-hexadecanol and n-octadecanol, and also technical mixtures composed of n-hexadecanol and n-octadecanol.

Stearyl alcohol is a particularly preferred lubricant or mould-release agent.

### Melt Volume Index MVR of the Moulding Composition

For the purposes of the present invention, the melt volume index MVR, measured to ISO 1133 for 230° C. and 3.8 kg, of the moulding composition is in the range from 0.1 cm³/10 min to 5.0 cm³/10 min. The MVR here, measured to ISO 1133 for 230° C. and 3.8 kg, is preferably at least 0.2 cm³/10 min, particularly preferably at least 0.3 cm³/10 min, advantageously at least 0.4 cm³/10 min, in particular at least 0.5 cm³/10 min. The MVR, measured to ISO 1133 for 230° C. and 3.8 kg, is moreover preferably smaller than 3.5 cm³/10 min, particularly preferably smaller than 3.0 cm³/10 min, advantageously smaller than 1.5 cm³/10 min, very particularly preferably smaller than 1.4 cm³/10 min, in particular smaller than 1.1 cm³/10 min, and most preferably smaller than 0.9 cm³/10 min. In the case of moulding compositions with impact modifier, the MVR, measured to ISO 1133 for 230° C. and 3.8 kg, is preferably in the range from 0.1 cm³/10 min to 3.0 cm³/10 min. In the case of moulding compositions without impact modifier, the MVR, measured to ISO 1133 for 230° C. and 3.8 kg, is preferably in the range from 0.5 cm³/10 min to 5.0 cm³/10 min.

### Preparation of Inventive Moulding Composition

The inventive moulding composition can be prepared via dry blending of the components, which can take the form of powders, grains or preferably pellets. They can moreover also be prepared via melting and mixing in the melt of the polymer matrix and, if appropriate, of the impact modifier, or via melting of dry premixes of individual components, and addition of the ceramic beads. This can take place, for example, in single- or twin-screw extruders. The extrudate obtained can then be pelletized. Conventional additives, auxiliaries and/or fillers can be directly admixed or subsequently admixed by the end user as required.

### Processing to Give Mouldings

The inventive moulding composition is a suitable starting material for production of mouldings with a velvet-matt and preferably rough surface. The forming process to which the moulding composition is subjected can take place in a manner known per se, e.g. via processing by way of the elastoviscous state, e.g. via kneading, rolling, calendering, extrusion or injection moulding, preference being presently given to extrusion and injection moulding, in particular extrusion.

The moulding composition can be injection-moulded in a manner known per se at temperatures in the range from 220° C. to 260° C. (melt temperature) and at a mould temperature which is preferably from 60° C. to 90° C. When moulds are used whose mould cavities have smooth or polished interior surfaces (cavities), matt mouldings are obtained. When moulds are used whose mould cavities have rough interior surfaces (cavities), the mouldings obtained are even more intensely matt.

Extrusion is preferably carried out at a temperature of from 220° C. to 260° C.

### Mouldings

The mouldings thus obtainable preferably feature the following properties:

The roughness value R_{z} to DIN 4768 is advantageously greater than or equal to 0.3 μm, preferably at least 0.7 μm, particularly preferably from 2.5 μm to 20.0 μm. Gloss (R) 60° to DIN 67530 (01/1982) is preferably at most 45%, particularly preferably at most 38%. Transmittance to DIN 5036 is preferably in the range from 40% to 93%, particularly preferably in the range from 55% to 93%, in particular in the range from 55% to 85%. The halved-intensity angle to DIN 5036 is preferably in the range from 1° to 55°, particularly preferably in the range from 2° to 40°, in particular in the range from 8° to 37°.

For the purposes of one particularly preferred embodiment of the present invention, the Vicat softening point VSP (ISO 306-B50) of the moulding is preferably at least 90° C., particularly preferably at least 95° C., very particularly preferably at least 100° C., being advantageously from 90° C. to 170° C., in particular from 102° C. to 130° C. The moulding moreover preferably has one or more, particularly preferably as many as possible, of the following properties:
I. a tensile stress at break to ISO 527 (5 mm/min) of at least 50 MPa, in particular in the range from 65 MPa to 90 MPa,
II. a modulus of elasticity to ISO 527 greater than 3200 MPa,
III. an impact resistance to ISO 179/1 eU greater than 20 kJ/m² and
IV. a coefficient of linear expansion to ISO 11359 smaller than 8*10⁻⁵/° K., particularly preferably smaller than 7.1*10⁻⁵/° K.

These mouldings are usually obtained from moulding compositions which comprise no impact modifier.

For the purposes of a second particularly preferred embodiment of the present invention, the Vicat softening point VSP (ISO 306-350) of the moulding is preferably at least 90° C., particularly preferably at least 95° C. and advantageously from 90° C. to 170° C., in particular from 95° C. to 110° C. The moulding moreover preferably has one or more, particularly preferably as many as possible, of the following properties:
I. a yield stress to ISO 527 for 50 mm/min of at least 30 MPa, in particular in the range from 34 MPa to 50 MPa,
II. a modulus elasticity to ISO 527 greater than 1400 MPa,
III. an impact resistance to ISO 179/1 eU greater than 4 kJ/m² and
IV. a coefficient of linear expansion to ISO 11359 smaller than 12*10⁻⁵/° K.

These mouldings are usually obtained from moulding compositions which comprise at least one impact modifier.

### Uses

The inventive mouldings can in particular be used as parts of household devices, of communications devices, of hobby equipment or of sports equipment, or as bodywork parts or parts of bodywork parts in automobile construction, shipbuilding or aircraft construction, or as parts for illuminants, signs or symbols, retail outlets or cosmetics counters, containers, household-decoration items or office-decoration items, furniture applications, shower doors and office doors, or else as parts, in particular sheets, in the construction industry, as walls, in particular as noise barriers, as window frames, bench seats, lamp covers, diffuser sheets, or for automobile glazing. Examples of typical exterior automobile parts are spoilers, panels, roof modules or exterior-mirror housings.

### EXAMPLES

Examples are used below for further illustration of the invention, but with no intention of any resultant restriction of the inventive concept.

PLEXIGLAS® 7H, PLEXIGLAS® 8N, PLEXIGLAS® zk6BR and PLEX®8908F from Roehm GmbH were used as polymer matrix.

The products Zeeospheres W-210, W-410, G-200 and G-400 from 3M Deutschland GmbH were used as ceramic beads.

The individual components were blended by means of a single-screw extruder. The constitutions of the individual examples are documented in Table 1.

The volume flow index MVR (ISO 1133: 1997 test standard) and the density of the moulding compositions were determined.

Injection moulding and strip extrusion were used to produce test specimens from the blended moulding compositions. No metal abrasion was observed during processing, either in the case of strip extrusion or in the case of injection moulding. The corresponding test specimens were tested by the following methods:

### Injection Mouldings

Vicat (16 h/80° C.): Determination of Vicat softening point (DIN ISO 306: August 1994 test standard)
NIR (Charpy 179/1 eU): Determination of Charpy notched impact resistance (Iso 179: 1993 Test Standard)
IR (Charpy 179/1 eU): Determination of Charpy impact resistance (ISO 179: 1993 test standard)
Modulus of elasticity: Determination of modulus of elasticity (ISO 527-2 test standard)
Tensile strength: Determination of tensile stress at break (ISO 527 test standard; 5 mm/min), of yield stress (ISO 527 test standard; 50 mm/min) and/or of tensile strain at yield (ISO 527 test standard; 50 mm/min)
Transmittance (T): To DIN 5036
Halved-intensity angle (HIA): Measured to DIN 5036 using a GO-T-1500 goniometer test unit from LMT
Coefficient of linear expansion: ISO 11359 (from 0° C. to 50° C.)
Scratch hardness: To Erichsen 413

### Strips:

Surface roughness: Ra, Rz and Rt roughness variables to DIN 4768. Ra values<2 μm were determined using a cut-off of 0.8 mm, and if Ra was greater than or equal to 2 μm the cut-off was 2.5 mm. A Form Talysurf 50 produced by Rank Taylor Hobson GmbH was used to carry out the roughness measurements.
Gloss: Gloss measurement to DIN 67530 (01/1982): “Reflectometer as a means for gloss assessment of plane surfaces of paint coatings and plastics”

The results of the tests on the blends and on the corresponding mouldings are found in Table 2. The improvements achieved via the present invention are clearly visible:

The use of ceramic beads as matting agent permits the corresponding moulding compositions to be used to extrude strips which have relatively low gloss and a uniform fine-matt surface, and attractive surface roughness. Improved scattering action is moreover found, as also are a reduction in the coefficient of expansion and an improvement in mechanical properties, such as impact resistance, notched impact resistance, modulus of elasticity and scratch resistance.

TABLE 1
Constitution of moulding compositions

| | | | Zeeospheres ® | | | |
|---|---|---|---|---|---|---|
| | PLEXIGLAS ® | | W-210¹ | W-410² | G³-200 | G⁴-400 |
| | 7H [% by | 8N [% by | [% by | [% by | [% by | [% by |
| | wt.] | wt.] | wt.] | wt.] | wt.] | wt.] |
| E1 | 99 | | 1 | | | |
| E2 | 95 | | 5 | | | |
| E3 | 90 | | 10 | | | |
| E4 | 99 | | | 1 | | |
| E5 | 95 | | | 5 | | |
| E6 | 90 | | | 10 | | |
| E7 | 99 | | | | 1 | |
| E8 | 95 | | | | 5 | |
| E9 | 90 | | | | 10 | |
| E10 | 99 | | | | | 1 |
| E11 | 95 | | | | | 5 |
| E12 | 90 | | | | | 10 |
| E13 | | 99 | | | 1 | |
| E14 | | 95 | | | 5 | |

| | PLEXIGLAS ® | | Zeeospheres ® |
|---|---|---|---|
| | zk6BR | PLEX 8908F | W-210¹ |
| | [% by wt.] | [% by wt.] | [% by wt.] |
| E15 | 99 | | 1 |
| E16 | 95 | | 5 |
| E17 | 90 | | 10 |
| E18 | | 99 | 1 |
| E19 | | 95 | 5 |
| E20 | | 90 | 10 |

¹D₅₀: 3 μm, D₉₅: 12 μm;
²D₅₀: 4 μm, D₉₅: 24 μm,
³D₅₀: 4 μm, D₉₅: 12 μm,
⁴D₅₀: 5 μm, D₉₅: 24 μm

TABLE 2
Properties of moulding compositions/mouldings

| | 7H | E1 | E2 | E3 | E4 | E5 | E6 | E7 |
|---|---|---|---|---|---|---|---|---|
| MVR [cm³/10 min] | 1.4 | 1.2 | 1.0 | 0.9 | 1.1 | 1.0 | 0.9 | 1.2 |
| Vicat [° C.] | 103 | 103 | 104 | 104 | 104 | 104 | 104 | 103 |
| Density [g/cm³] | 1.19 | 1.20 | 1.22 | 1.25 | 1.20 | 1.22 | 1.26 | |
| HIA [°] | 0 | 2 | 17 | 36 | 2 | 10 | 24 | |
| T [%] | 92 | 93 | 78 | 59 | 93 | 84 | 68 | |
| Ra [μm] | | 0.6 | 1.2 | 1.6 | 0.8 | 1.8 | 2.8 | |
| Rz [μm] | | 3.9 | 6.9 | 9.0 | 4.9 | 10.1 | 16.4 | |
| Rt [μm] | | 5.0 | 8.9 | 11.5 | 7.1 | 13.8 | 20.4 | |
| IR [kJ/m²] | 23 | 28 | 32 | 26 | 26 | 23 | 22 | 31 |
| NIR [kJ/m²] | 1.4 | | | | | | | 1.4 |
| Tensile stress at | 76 | 72 | 73 | 73 | 73 | 73 | 72 | 86 |
| break (5 mm/min) [MPa] | | | | | | | | |
| Modulus of elasticity | 3200 | 3480 | 3650 | 3860 | 3490 | 3610 | 3840 | 3430 |
| (1 mm/min) [MPa] | | | | | | | | |
| Coefficient of linear | 8 | 6.5 | 6.3 | 6.0 | 6.5 | 6.2 | 6.0 | |
| expansion [10⁻⁵/K] | | | | | | | | |
| Scratch hardness | | 3H | 4H | 4H | 3H | 4H | 5H | 4H |
| | E8 | E9 | E10 | E11 | E12 | 8N | E13 | E14 |
| MVR [cm³/10 min] | 1.1 | 1.0 | 1.1 | 1.0 | 1.0 | 3 | 3.4 | 3.3 |
| Vicat [° C.] | 103 | 104 | 103 | 103 | 104 | 108 | 107 | 107 |
| Density [g/cm³] | | | | | | 1.19 | 1.19 | 1.22 |
| HIA [°] | | | | | | 0 | | |
| T [%] | | | | | | 92 | | |
| Ra [μm] | | | | | | | 0.1 | 0.1 |
| Rz [μm] | | | | | | | 0.3 | 0.6 |
| Rt [μm] | | | | | | | 0.5 | 0.8 |
| IR [kJ/m²] | 28 | 26 | 27 | 23 | 21 | 20 | 22 | 23 |
| NIR [kJ/m²] | 1.4 | 1.5 | 1.4 | 1.4 | 1.4 | | | |
| Tensile stress at | 85 | 84 | 87 | 85 | 85 | 77 | 71 | 74 |
| break (5 mm/min) [MPa] | | | | | | | | |
| Modulus of elasticity | 3560 | 3750 | 3460 | 3580 | 3730 | 3300 | 3430 | 3580 |
| (1 mm/min) [MPa] | | | | | | | | |
| Coefficient of linear | | | | | | 8 | 6.3 | 6.6 |
| expansion [10⁻⁵/K] | | | | | | | | |
| Scratch hardness | 5H | 4H | 3H | 3H | 3H | | | |
| | | | | | PLEX | | | |
| | zk6BR | E15 | E16 | E17 | 8908F | E18 | E19 | E20 |
| MVR [cm³/10 min] | 1.5 | 1.5 | 1.4 | 1.3 | 0.3 | 0.2 | 0.2 | 0.1 |
| Vicat [° C.] | 98 | 98 | 98 | 98 | 89 | 90 | 91 | 91 |
| Ra [μm] | 0.1 | 0.2 | 0.4 | 0.4 | 0.2 | 0.3 | 0.5 | 0.7 |
| Rz [μm] | 0.9 | 1.6 | 3.0 | 3.4 | 1.9 | 2.5 | 3.8 | 5.1 |
| Rt [μm] | 0.2 | 3.1 | 5.7 | 5.9 | 3.3 | 3.9 | 5.2 | 7.2 |
| IR [kJ/m²] | | | | | | | | |
| NIR [kJ/m²] | 7.2 | 6.4 | 5.1 | 4.8 | 9.8 | 6.7 | 6.4 | 5 |
| Yield stress | 46 | 46 | 46 | 46 | 37 | 37 | 36 | 37 |
| (50 mm/min) [MPa] | | | | | | | | |
| Tensile strain at | 5.4 | 5.1 | 4.7 | 4.5 | 4.8 | 4.9 | 4.7 | 4.5 |
| yield (50 mm/min) [%] | | | | | | | | |
| Modulus of elasticity | 1760 | 1800 | 1870 | 1990 | 1510 | 1500 | 1570 | 1670 |
| (1 mm/min) [MPa] | | | | | | | | |
| Coefficient of linear | 9.6 | 9.7 | 9.5 | 9.1 | 1.1 | 1.2 | 1.1 | 1.0 |
| expansion | | | | | | | | |
| [10⁻⁵/K] | | | | | | | | |
| Scratch hardness | F | B | 2B | 4B | B | 2B | 4B | 6B |

| | 7H | E1 | E2 | E3 | E4 | E5 | E6 | E7 | E8 | E9 | E10 | E11 | E12 | E13 | E14 |
|---|---|---|---|---|---|---|---|---|---|---|---|---|---|---|---|
| Glass [%] | | | | | | | | | | | | | | | |
| R (20°) | 78 | 5 | 1 | 1 | 4 | 1 | 1 | 3 | 1 | 0 | 3 | 1 | 0 | | |
| R (60°) | 89 | 37 | 11 | 7 | 29 | 10 | 6 | 22 | 7 | 5 | 26 | 8 | 5 | | |
| R (85°) | 97 | 55 | 17 | 11 | 42 | 14 | 7 | 39 | 13 | 9 | 44 | 14 | 9 | | |
| Erichsen | | | | | | | | | | | | | | | |
| scratch | | | | | | | | | | | | | | | |
| hardness [μm] | | | | | | | | | | | | | | | |
| 1N | | 0.4 | 0.4 | | 0.2 | 1.2 | | | | | | | | | |
| 3N | 2.3 | 2.6 | 2.3 | 2.2 | 2.55 | 2.3 | 2.2 | 2.5 | 2.2 | 2.2 | 2.3 | 2.2 | 2.0 | | |
| 5N | 17.7 | 18 | 19.7 | 18.5 | 18.2 | 17.8 | 21.1 | 16.0 | 19.5 | 19.4 | 15.6 | 16.4 | 19.1 | | |
| 7N | 27.4 | 31 | 26.1 | 28.7 | 29.7 | 28.1 | 32.3 | 29.5 | 26.8 | 27.1 | 31.4 | 25.9 | 28.5 | | |
| 10N | 38 | 42 | 44.4 | 40.3 | 47.1 | 39.3 | 40.3 | 42.5 | 43.2 | 38.5 | 42.4 | 39.4 | 41.0 | | |

| | zk6BR | E15 | E16 | E17 | PLEX 8908 | E18 | E19 | E20 |
|---|---|---|---|---|---|---|---|---|
| Glass [%] | | | | | | | | |
| R (20°) | 12 | 10 | 5 | 4 | | | | |
| R (60°) | 60 | 55 | 37 | 32 | | | | |
| R (85°) | 91 | 87 | 63 | 57 | | | | |

1. A moulding composition, comprising, based in each case on the total weight of the moulding composition,
A) from 49.5% by weight to 99.5% by weight of a polymer matrix comprising a (meth)acrylate (co)polymer or a mixture comprising (meth)acrylate (co)polymer,
B) from 0.5% by weight to 15.0% by weight of ceramic beads, wherein
the melt volume index MVR, according to ISO 1133 for 230° C. and 3.8 kg, of the moulding composition is from 0.1 cm³/10 min to 5.0 cm³/10 min.

2. The moulding composition according to claim 1, wherein the ceramic beads have no covalent bonding to the polymer matrix.

3. The moulding composition according to claim 1, wherein the median diameter, measured as D₅₀ value, of the ceramic beads is in the range from 1.0 μm to 15.0 μm.

4. The moulding composition according to claim 1, wherein the median diameter, measured as D₉₅ value, of the ceramic beads is in the range from 3 μm to 35 μm.

5. The moulding composition according to claim 1, wherein the density of the ceramic beads is in the range from 2.1 g/cm³ to 2.5 g/cm³.

6. The moulding composition according to claim 1, wherein the ceramic beads comprise, based in each case on their total weight,
from 55.0% by weight to 62.0% by weight of SiO₂,
from 21.0% by weight to 35.0% by weight of Al₂O₃,
up to 7.0% by weight of Fe₂O₃,
up to 11.0% by weight of Na₂O and
up to 6.0% by weight of K₂O.

7. The moulding composition according to claim 1, wherein the surface area, measured by the BET nitrogen adsorption method, of the ceramic beads is in the range from 0.8 m²/g to 2.5 m²/g.

8. The moulding composition according to claim 1, wherein the ceramic beads are internally hollow.

9. The moulding composition according to claim 1, wherein the moulding composition comprises, based on its total weight, from 0.1% by weight to 15.0% by weight of at least one impact modifier C), which has no covalent bonding to the polymer matrix.

10. The moulding composition according to claim 9, wherein the impact modifier C) has poly(meth)acrylate units.

11. The moulding composition according to claim 9, wherein the impact modifier C) has a two- or three-shell structure.

12. The moulding composition according to claim 1, wherein the polymer matrix A) comprises a (meth)acrylate (co)polymer comprises from 96.0% by weight to 100.0% by weight of methyl methacrylate and from 0.0 to 4.0% by weight of at least one of methyl acrylate, ethyl acrylate and butyl acrylate.

13. The moulding composition according to claim 1, wherein the polymer matrix A) comprises a copolymer comprising methyl methacrylate, styrene and maleic anhydride.

14. The moulding composition according to claim 13, wherein the polymer matrix A) comprises a copolymer comprising
from 50 to 90% by weight of methyl methacrylate,
from 10 to 20% by weight of styrene and
from 5 to 15% by weight of maleic anhydride.

15. The moulding composition according to claim 1, wherein the moulding composition comprises at least one of following components:
d) a low-molecular-weight (meth)acrylate (co)polymer, wherein a solution viscosity in chloroform at 25° C. (ISO 1628 Part 6) is smaller than or equal to 55 ml/g;
e) a relatively high-molecular-weight (meth)acrylate (co)polymer, wherein a solution viscosity in chloroform at 25° C. (ISO 1628—Part 6) is greater than or equal to 65 ml/g and
f) another (meth)acrylate (co)polymer differing from d) wherein a solution viscosity in chloroform at 25° C. (ISO 1628—Part 6) is from 50 to 55 ml/g,
where each of components d), e), and f) can be an individual polymer or a mixture of polymers.

16. The moulding composition according to claim 1, wherein the melt volume index MVR, measured to ISO 1133 for 230° C. and 3.8 kg, of the moulding composition is in the range from 0.1 cm³/10 min to 3.0 cm³/10 min.

17. The moulding composition according to claim 1, wherein the melt volume index MVR, measured to ISO 1133 for 230° C. and 3.8 kg, of the moulding composition is in the range from 0.5 cm³/10 min to 3.0 cm³/10 min.

18. The moulding composition according to claim 1, wherein a lubricant is present as auxiliary.

19. The moulding composition according to claim 18, wherein stearyl alcohol is present as lubricant.

20. The moulding composition according to claim 1, wherein a pellet comprises the moulding composition.

21. A process for production of a moulding comprising forming a moulding from the moulding composition according to claim 1.

22. A process according to claim 21, wherein the moulding composition is extruded or injection-moulded.

23. A moulding obtained by the process according to claim 21.

24. The moulding according to claim 23, wherein a Rz roughness value to DIN 4768 is at least 0.3 μm and a gloss (R 60°) to DIN 67530 is at most 45.

25. The moulding according to claim 23, wherein a transmittance to DIN 5036 is in the range from 40% to 93% and a halved-intensity angle to DIN 5036 is in the range from 1° to 55°.

26. The moulding according to claim 23, wherein the moulding comprises one or more of following properties:
a. a Vicat softening point to ISO 306-B50 of at least 90° C.,
b. a tensile stress at break to ISO 527 for 5 mm/min of at least 50 MPa,
c. a modulus of elasticity to ISO 527 greater than 3200 MPa,
d. an impact resistance to ISO 179/1 eU greater than 20 kJ/m² and
e. a coefficient of linear expansion to ISO 11359 smaller than 8*10⁻⁵/° K.

27. The moulding according to claim 23, wherein the moulding comprises one or more of following properties
a. a Vicat softening point to ISO 306-B50 of at least 90° C.,
b. a yield stress to ISO 527 for 50 mm/min of at least 30 MPa,
c. a modulus of elasticity to ISO 527 greater than 1400 MPa,
d. an impact resistance to ISO 179/1 eU greater than 4 kJ/m² and
e. a coefficient of linear expansion to ISO 11359 smaller than 12*10⁻⁵/° K.

28. (canceled)
